(19) United States
(12) Patent Application Publication
(10) Pub. No.: US 2013/0104838 A1
(43) Pub. Date: May 2, 2013

(54) Piston for an internal combustion engine

(71) Applicant: MAHLE INTERNATIONAL GMBH, Stuttgart (DE)

(72) Inventor: Stefan SPANGENBERG, Stuttgart (DE)

(73) Assignee: MAHLE INTERNATIONAL GMBH, Stuttgart (DE)

(21) Appl. No.: 13/650,208

(22) Filed: Oct. 12, 2012

(30) Foreign Application Priority Data
Oct. 13, 2011 (DE) 10 2011 115 826.3

(51) Int. Cl. F02F 3/16

(52) U.S. Cl. CPC F02F 3/16
USPC 123/193.6

(57) ABSTRACT

The present invention relates to a piston (10, 110, 210, 310) for an internal combustion engine, having a piston base body (11, 111, 211, 311) and a piston head element (12, 112, 212, 312), wherein the piston base body (11, 111, 211, 311) has a piston skirt (16) that is provided with pin bosses (18) having pin bores (17), wherein the piston head element (12, 112, 212, 312) forms at least one part of a piston head (25, 125, 225, 325), and wherein a circumferential cooling channel (26, 126, 226, 326) is provided in the piston head (25, 125, 225, 325). According to the invention, it is provided that at least one heat conduction element (27, 127, 227, 327) is disposed in the cooling channel (26, 126, 226, 326).

The present invention relates to a piston for an internal combustion engine, having a piston base body and a piston head element, wherein the piston base body has a piston skirt that is provided with pin bosses having pin bores, wherein the piston head element forms at least one part of a piston head, and wherein a circumferential cooling channel is provided in the piston head.

In modern pistons, the piston head is subject to great mechanical and thermal stresses, particularly in the region of the piston crown. In this connection, the problem arises that at temperatures above 280° C., the cooling oil present in the circumferential cooling channel is decomposed thermally. In this connection, oil carbon is formed, which deposits on the inner walls of the cooling channel. The oil carbon has a heat-insulating effect, so that the cooling performance of the cooling oil in the cooling channel is reduced.

The task of the present invention therefore consists in further developing a piston of the stated type in such a manner that improved heat dissipation in the direction of the piston skirt is possible.

The solution consists in that at least one heat conduction element is disposed in the cooling channel.

The at least one heat conduction element provided according to the invention ensures improved heat dissipation, proceeding from the piston crown, in the direction of the piston skirt. In this way, the risk of oil carbon formation in the cooling channel is clearly reduced.

Advantageous further developments are evident from the dependent claims.

Preferably, the at least one heat conduction element is soldered or welded to at least one inner wall of the cooling channel. This represents a possibility for production of the piston according to the invention that can be implemented in particularly simple and cost-advantageous manner.

If the at least one heat conduction element is attached at a distance (d) from the bottom of the cooling channel that amounts to at least 10% of the width (b) of the cooling channel, the cooling oil present in the cooling channel can flow around the at least one heat conduction element in particularly effective manner.

If the piston base body and the piston head element are connected with one another by way of weld seams, the at least one heat conduction element can be linked with at least one weld seam in particularly simple manner. In this embodiment, the at least one heat conduction element is attached in the cooling channel at the same time with the welding of piston base body and piston head element, so that one method step, namely the separate attachment of the at least one heat conduction element in the cooling channel, is eliminated.

It is practical if the at least one heat conduction element consists of a material having a high heat conductivity coefficient. Materials on the basis of at least one metal, which is selected from the group comprising aluminum, copper, and iron, are preferred. The material can contain graphite, if necessary, for example in order to increase its strength.

The at least one heat conduction element is preferably configured as a heat conduction sheet, in order to be given the largest possible surface area for heat exchange. For the same reason, and in order to optimize the flow conditions for the cooling oil present in the cooling channel, the at least one heat conduction element can contain one or more openings.

The at least one heat conduction element can have any desired cross-sectional shape. This is dependent on the size of the cooling channel and on the desired size of the surface area of the at least one heat conduction element. For example, L-shaped, U-shaped, V-shaped, W-shaped, or WW-shaped cross-sectional shapes are possible. The at least one heat conduction element can furthermore also be configured as a three-dimensional network.

The piston head element is preferably configured as a piston ring element or as a bowl edge reinforcement of a combustion bowl. This makes it possible to produce the region of the piston that is subject to particularly high thermal and mechanical stress from a material suitable for this purpose. Of course, the piston head element can also comprise the entire piston head, for example with a cooling channel that is open downward and closed off with a separate component.

Fundamentally, the piston base body can be produced from a metallic material, and the piston head element can be produced from a wear-resistant and/or temperature-resistant material. In this connection, steel materials are preferred.

Exemplary embodiments of the present invention will be explained in greater detail below, using the attached drawings. These show, in a schematic representation, not true to scale:

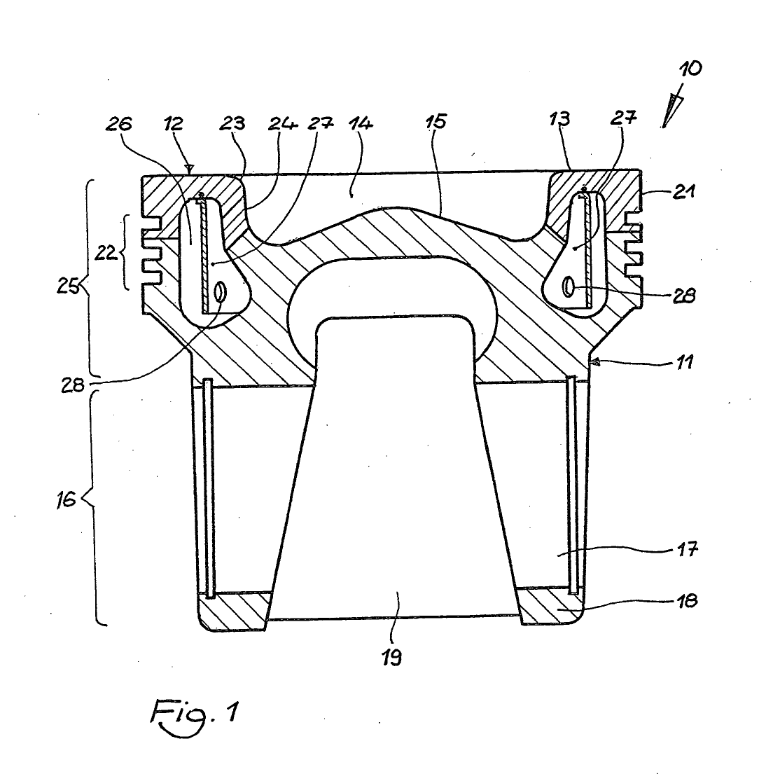

FIG. 1 a first embodiment of a piston according to the invention, in section;

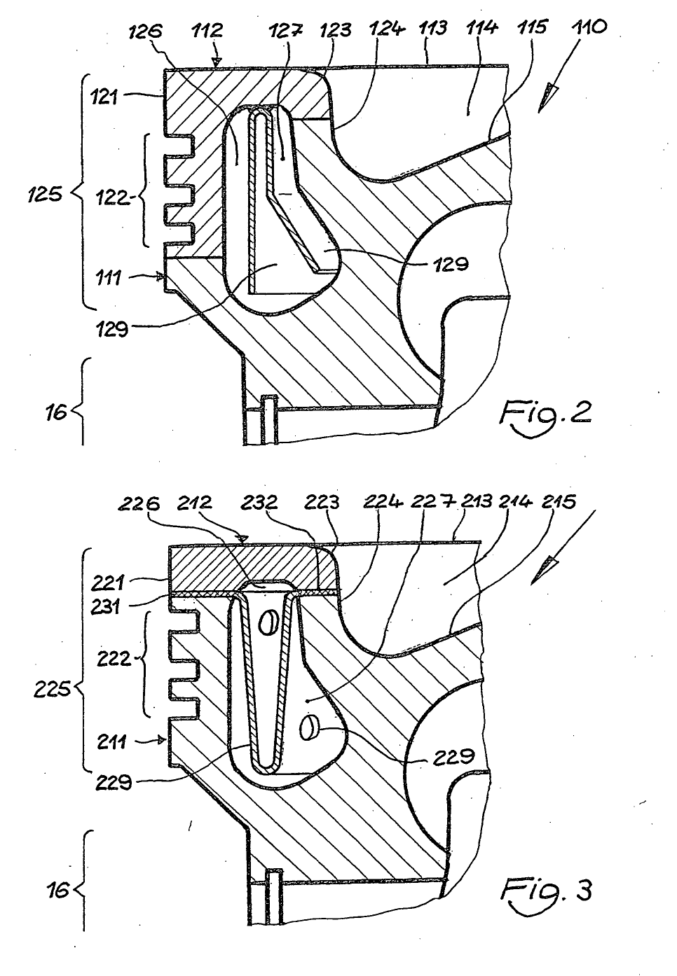

FIG. 2 an enlarged partial representation of another embodiment of a piston according to the invention, in section;

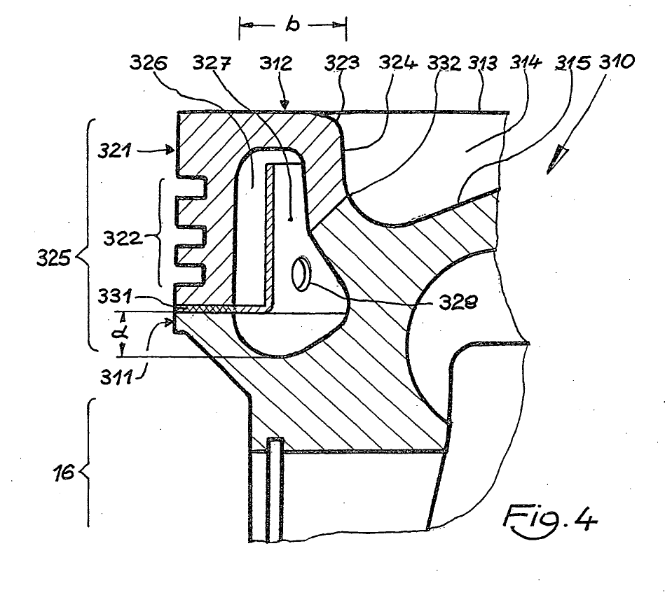

FIG. 3 an enlarged partial representation of another embodiment of a piston according to the invention, in section;

FIG. 4 an enlarged partial representation of another embodiment of a piston according to the invention, in section.

FIG. 1 shows a first exemplary embodiment of a piston 10 according to the invention. The piston 10 has a piston base body 11 and a piston head element 12. In this exemplary embodiment, the piston base body 11 forms the crown 15 of a combustion chamber bowl 14. A piston skirt 16, which has pin bosses 18 provided with pin bores 17, as well as working surfaces 19, is linked to the underside of the piston crown 13, in known manner. The piston base body 11 furthermore forms the part of a circumferential ring belt 22 having ring grooves for piston rings (not shown). The piston base body 11 can be produced from a steel material, for example.

In this exemplary embodiment, the piston head element 12 forms the outer region of the piston crown 13 having a circumferential top land 21 as well as the upper part of the circumferential ring belt 22 having ring grooves for piston rings (not shown). The piston head element 12 furthermore forms the outer bowl edge 23 and the bowl wall 24 of the combustion chamber bowl 14. The piston head element 12 can be produced from a wear-resistant and/or temperature-resistant steel material, for example.

The piston base body 11 and the piston head element 12 therefore jointly form the piston head 25 of the piston 10. The piston base body 11 and the piston head element 12 furthermore jointly form a circumferential cooling channel 26 approximately at the level of the ring belt 22. The piston base body 11 and the piston head element 12 are connected with one another by means of welding in the exemplary embodiment.

In the exemplary embodiment, a heat conduction element 27 is provided in the cooling channel 26, according to the invention. In this exemplary embodiment, the heat conduction element 27 is configured as a ring-shaped, circumferential, flat heat conduction sheet. Of course, multiple heat conduction elements or multiple heat conduction elements in the manner of ring segments can also be provided, which are disposed offset from one another, if necessary. In the exemplary embodiment, the heat conduction element 27 is provided with openings 28 through which the cooling oil accommodated in the cooling channel can flow.

For assembly, the heat conduction element 27 is soldered or welded onto an inner wall of the cooling channel 26, in the piston head element 12, before piston base body 11 and piston head element 12 are connected. Subsequently, the piston base body 11 and the piston head element 12 are connected with one another, by means of a welding method in the case of the exemplary embodiment. Of course, the heat conduction element 27 can be attached at any desired location on the inner wall of the cooling channel 26, in other words also on the piston base body 11.

FIG. 2 shows another exemplary embodiment of a piston 110 according to the invention, in an enlarged partial representation. The piston 110 has a piston base body 111 and a piston head element 112. In this exemplary embodiment, the piston base body 111 forms the crown 115 and the circumferential bowl wall 124 of a combustion chamber bowl 114. A piston skirt 16 is linked to the underside of the piston crown 113, in known manner. The piston skirt 16 of the piston 110, including pin bores, pin bosses, and working surfaces, corresponds to the piston skirt 16 according to FIG. 1, so that reference is made to the above description. The piston base body 111 can be produced from a steel material, for example.

In this exemplary embodiment, the piston head element 112 forms the outer region of the piston crown 113 having a circumferential top land 121 and a circumferential ring belt 122 having ring grooves for piston rings (not shown). The piston head element 112 furthermore forms the outer bowl edge 123 of the combustion chamber bowl 114. The piston head element 112 can be produced from a wear-resistant and/or temperature-resistant steel material, for example.

The piston base body 111 and the piston head element 112 therefore jointly form the piston head 125 of the piston 110. The piston base body 111 and the piston head element 112 furthermore jointly form a circumferential cooling channel 126 approximately at the level of the ring belt 122. The piston base body 111 and the piston head element 112 are connected with one another by means of welding.

In the exemplary embodiment, a heat conduction element 127 is provided in the cooling channel 126, according to the invention. In this exemplary embodiment, the heat conduction element 127 is configured as a ring-shaped, circumferential heat conduction sheet having a U-shaped cross-section. The heat conduction element 127 therefore forms two shanks 129, which are essentially adapted to the contour of the cooling channel 126 in the exemplary embodiment, in order to achieve as effective a transfer of heat as possible. Of course, multiple heat conduction elements or multiple heat conduction elements in the manner of ring segments can also be provided, which are disposed offset from one another, if necessary.

For assembly, the heat conduction element 127 is soldered or welded onto an inner wall of the cooling channel 126, in the region of the U-shaped crosspiece, in the piston head element 112, before piston base body 111 and piston head element 112 are connected. Subsequently, the piston base body 111 and the piston head element 112 are connected with one another, by means of a welding method in the case of the exemplary embodiment. Of course, the heat conduction element 127 can be attached at any desired location on the inner wall of the cooling channel 126, in other words also on the piston base body 111.

FIG. 3 shows another exemplary embodiment of a piston 210 according to the invention, in an enlarged partial representation. The piston 210 has a piston base body 211 and a piston head element 212. In this exemplary embodiment, the piston base body 211 forms the crown 215 and the circumferential bowl wall 224 of a combustion chamber bowl 214. The piston base body 211 furthermore forms a circumferential ring belt 222 having ring grooves for piston rings (not shown). A piston skirt 16 is linked to the underside of the piston crown 213, in known manner. The piston skirt 16 of the piston 210, including pin bores, pin bosses, and working surfaces, corresponds to the piston skirt 16 according to FIG. 1, so that reference is made to the above description. The piston base body 211 can be produced from a steel material, for example.

In this exemplary embodiment, the piston head element 212 forms the outer region of the piston crown 213 having a circumferential top land 221. The piston head element 212 furthermore forms the outer bowl edge 223 of the combustion chamber bowl 214. The piston head element 212 can be produced from a wear-resistant and/or temperature-resistant steel material, for example.

The piston base body 211 and the piston head element 212 therefore jointly form the piston head 225 of the piston 210. The piston base body 211 and the piston head element 212 furthermore jointly form a circumferential cooling channel 226 approximately at the level of the ring belt 222. The piston base body 211 and the piston head element 212 are connected with one another by means of welding in the exemplary embodiment.

In the exemplary embodiment, a heat conduction element 227 is provided in the cooling channel 226, according to the invention. In this exemplary embodiment, the heat conduction element 227 is configured as a ring-shaped, circumferential heat conduction sheet having a V-shaped cross-section. The heat conduction element 227 therefore forms two shanks 229. In the exemplary embodiment, the heat conduction element 227 is provided with openings 228 through which the cooling oil accommodated in the cooling channel can flow. In this exemplary embodiment, the heat conduction element 227 is linked to the weld seams 231, 232, by way of which the piston base body 211 and the piston head element 212 are connected with one another, in the cooling channel 226, and in this way attached to the inner wall of the cooling channel 226. Of course, multiple heat conduction elements or multiple heat conduction elements in the manner of ring segments can also be provided.

For assembly, the heat conduction element 227 is laid onto the piston base body 211, before piston base body 211 and piston head element 212 are connected. For this purpose, flanges are provided on the heat conduction element 227, which are laid onto the joining surfaces of the piston base body 211 and fixed in place by means of spot welds, for example. Subsequently, the piston head element 212 is set onto the flanges of the heat conduction element 227 with its joining surfaces. Then, the piston base body 211 and the piston head element 212 are connected with one another, by means of a welding method. In this connection, the joining surfaces of piston base body 211 and piston head element 212 as well as the flanges provided on the heat conduction element connect to form the weld seams 231, 232.

FIG. 4 shows another exemplary embodiment of a piston 310 according to the invention, in an enlarged partial representation. The piston 310 has a piston base body 311 and a piston head element 312. In this exemplary embodiment, the piston base body 311 forms the crown 315 of a combustion chamber bowl 314. A piston skirt 16 is linked to the underside of the piston crown 313, in known manner. The piston skirt 16 of the piston 310, including pin bores, pin bosses, and working surfaces, corresponds to the piston skirt 16 according to FIG. 1, so that reference is made to the above description. The piston base body 311 can be produced from a steel material, for example.

In this exemplary embodiment, the piston head element 312 forms the outer region of the piston crown 313 having a circumferential top land 321 and a circumferential ring belt 322 having ring grooves for piston rings (not shown). The piston head element 312 furthermore forms the outer bowl edge 323 and the circumferential bowl wall 324 of the combustion chamber bowl 314. The piston head element 312 can be produced from a wear-resistant and/or temperature-resistant steel material, for example.

The piston base body 311 and the piston head element 312 therefore jointly form the piston head 325 of the piston 310. The piston base body 311 and the piston head element 312 furthermore jointly form a circumferential cooling channel 326 approximately at the level of the ring belt 322.

The piston base body 311 and the piston head element 312 are connected with one another by means of welding in the exemplary embodiment.

In the exemplary embodiment, a heat conduction element 327 is provided in the cooling channel 326, according to the invention. In this exemplary embodiment, the heat conduction element 327 is configured as a ring-shaped, circumferential heat conduction sheet having an L-shaped cross-section. The heat conduction element 327 extends essentially vertically in the direction of the piston crown 313 and has a free upper end. In the exemplary embodiment, the heat conduction element 327 is provided with openings 328 through which the cooling oil accommodated in the cooling channel can flow. In this exemplary embodiment, the heat conduction element 327 is linked to the lower weld seam 331, by way of which the piston base body 311 and the piston head element 312 are connected with one another, in the cooling channel 326, in the region of the ring belt 322, and in this way attached to the inner wall of the cooling channel 326. In this connection, the heat element 327 is attached at a distance (d) from the bottom of the cooling channel 326 that amounts to at least 10% of the width (b) of the cooling channel 326, in the exemplary embodiment. Of course, multiple heat conduction elements or multiple heat conduction elements in the manner of ring segments can also be provided.

For assembly, the heat conduction element 327 is laid onto the outer joining surface of the piston base body 311, before piston base body 311 and piston head element 312 are connected, and fixed in place by means of spot welds, for example. Subsequently, the piston head element 312 is set onto the piston base body 311 or the heat conduction element 327 respectively with its joining surfaces. Then, the piston base body 311 and the piston head element 312 are connected with one another, by means of a welding method. In this connection, the joining surfaces of piston base body 311 and piston head element 312 as well as the heat conduction element 327 connect to form the weld seam 331. The further weld seam 332 is formed only by piston base body 311 and piston head element 312.

Of course, all the variants with regard to size and shape of the heat conduction element as well as method and location of its attachment in the cooling channel can be combined with one another.

1. Piston (10, 110, 210, 310) for an internal combustion engine, having a piston base body (11, 111, 211, 311) and a piston head element (12, 112, 212, 312), wherein the piston base body (11, 111, 211, 311) has a piston skirt (16) that is provided with pin bosses (18) having pin bores (17), wherein the piston head element (12, 112, 212, 312) forms at least one part of a piston head (25, 125, 225, 325), and wherein a circumferential cooling channel (26, 126, 226, 326) is provided in the piston head (25, 125, 225, 325), wherein at least one heat conduction element (27, 127, 227, 327) is disposed in the cooling channel (26, 126, 226, 326).

2. Piston according to claim 1, wherein the at least one heat conduction element (27, 127, 227, 327) is attached to at least one inner wall of the cooling channel (26, 126, 226, 326) by means of welding or soldering.

3. Piston according to claim 1, wherein the at least one heat conduction element (27, 127, 227, 327) is attached at a distance (d) from the bottom of the cooling channel (26, 126, 226, 326) that amounts to at least 10% of the width (b) of the cooling channel (26, 126, 226, 326).

4. Piston according to claim 1, wherein the piston base body (211, 311) and the piston head element (212, 312) are connected with one another by way of weld seams (231, 232; 331, 332), and that the at least one heat conduction element (227, 327) is linked to at least one weld seam (231, 232; 331).

5. Piston according to claim 1, wherein the at least one heat conduction element (27, 127, 227, 327) is produced from a material on the basis of at least one metal that is selected from the group comprising aluminum, copper, and iron.

6. Piston according to claim 5, wherein the material of the at least one heat conduction element (27, 127, 227, 327) furthermore contains graphite.

7. Piston according to claim 1, wherein the at least one heat conduction element (27, 127, 227, 327) is configured as a heat conduction sheet.

8. Piston according to claim 1, wherein the at least one heat conduction element (27, 227, 327) contains one or more openings (28, 228, 328).

9. Piston according to claim 1, wherein the at least one heat conduction element (27, 127, 227, 327) has an L-shaped, U-shaped, V-shaped, W-shaped, or WW-shaped cross-section.

10. Piston according to claim 1, wherein the at least one heat conduction element (27, 127, 227, 327) is configured as a three-dimensional network.

11. Piston according to claim 1, wherein the piston head element (112) is configured as a piston ring element.

12. Piston according to claim 1, wherein the piston head element (12, 112, 212, 312) is configured as a bowl edge reinforcement of a combustion bowl (14, 114, 214, 314).

13. Piston according to claim 1, wherein the piston base body (11, 111, 211, 311) is produced from a metallic material, and that the piston head element (12, 112, 212, 312) is produced from a wear-resistant and/or temperature-resistant material.

14. Piston according to claim 13, the piston base body (11, 111, 211, 311) and/or the piston head element (12, 112, 212, 312) are produced from a steel material.
